(19) United States
(12) Patent Application Publication
(10) Pub. No.: US 2022/0373758 A1
(43) Pub. Date: Nov. 24, 2022

(54) METHOD FOR PRODUCING PLASTIC OPTICAL FIBER

(71) Applicant: NITTO DENKO CORPORATION, Osaka (JP)

(72) Inventors: Yasuaki OKADA, Osaka (JP); Takeshi SAITO, Osaka (JP)

(73) Assignee: NITTO DENKO CORPORATION, Osaka (JP)

(21) Appl. No.: 17/764,414

(22) PCT Filed: Sep. 30, 2020
(86) PCT No.: PCT/JP2020/037213

§ 371 Date: Mar. 28, 2022

(30) Foreign Application Priority Data
Sep. 30, 2019 (JP) 2019-179420

(51) Int. Cl. G02B 6/44; B29D 11/00

(52) U.S. Cl. CPC G02B 6/4483; G02B 6/4482; B29D 11/00721

(57) ABSTRACT

A method for producing a plastic optical fiber including a step of dispersing a pigment in a curable composition containing an active-energy-ray-curable resin and the pigment, and a step of forming a coloring member made from a cured product of the curable composition by applying the curable composition on a peripheral surface of a plastic optical fiber body. The curable composition has a viscosity of 2,000 mPa or more and 3,000 mPa or less at 25° C. In the step of dispersing the pigment, the curable composition is charged into an airtight container having a circular tubular shape with an axis A1 and the airtight container is rotated around the axis A1 intersecting with a vertical line at a circumferential velocity of 0.02 m/sec or more and 0.2 m/sec or less.

The present invention relates to a method for producing a plastic optical fiber.

### BACKGROUND ART

A conventional method in which a curable composition containing a pigment and an ultraviolet curable resin is applied on a peripheral surface of a fiber body including a core to form an ink layer made from a cured product of the curable composition has been known (for example, see Patent document 1 below).

The optical fiber described in Patent document 1 can be distinguished by the color or pattern of the ink layer.

### CITATION LIST

### Patent Document

Patent Document 1: Japanese Translation of PCT International Application Publication No. 2012-508395

### SUMMARY OF THE INVENTION

### Problem to be Solved by the Invention

The pigment, however, tends to settle in the curable composition. In other words, the pigment tends to exist in an inhomogeneous state in the curable composition. There is a disadvantage that the application of such a curable composition on a fiber body forms an ink layer with insufficient distinguishability.

When the curable composition is stirred using an agitator with a stirring blade to make the curable composition sufficiently homogeneous, air bubbles tend to be formed in the curable composition during the stirring. There is a disadvantage that the application of such a curable composition on the fiber body forms an ink layer with insufficient distinguishability, especially, with a defect due to air bubbles.

The present invention provides a method for producing a plastic optical fiber in which the coloring member has excellent distinguishability and the defects of the coloring member are suppressed.

### Means for Solving the Problem

The present invention [1] includes a method for producing a plastic optical fiber, the method including: a step of dispersing a pigment in a curable composition containing an active-energy-ray-curable resin and the pigment; and a step of forming a coloring member made from a cured product of the curable composition by applying the curable composition on a peripheral surface of a plastic optical fiber body, wherein the curable composition has a viscosity of 2,000 mPa or more and 3,000 mPa or less at 25° C., and in the step of dispersing the pigment, the curable composition is charged into an airtight container having a circular tubular shape with an axis and the airtight container is rotated around the axis intersecting with a vertical line so that an internal surface of the circular tube rotates at a circumferential velocity of 0.02 m/sec or more and 0.2 m/sec or less.

### Effects of the Invention

In the method for producing a plastic optical fiber of the present invention, the curable composition with a specific viscosity is charged into an airtight container having a circular tubular shape with an axis intersecting with a vertical line, and the airtight container is rotated around the axis so that the internal surface of the circular tube rotates at a circumferential velocity of 0.02 m/sec or more and 0.2 m/sec or less, namely, a low speed. Thus, the mixing of air bubbles can be suppressed while the pigment homogeneously exists in the curable composition. As a result, a plastic optical fiber is produced while the coloring member has excellent distinguishability and the defects of the coloring member are suppressed.

### BRIEF DESCRIPTION OF THE DRAWINGS

FIG. 1A and FIG. 1B illustrate steps of one embodiment of the method for producing a plastic optical fiber of the present invention. FIG. 1A illustrates a step of preparing a plastic optical fiber body. FIG. 1B illustrates a step of forming a coloring member.

FIG. 2A and FIG. 2B are views depicting a rotary device in which an airtight container is set. FIG. 2A is a side view thereof. FIG. 2B is a cross-sectional frontal view taken along line X-X of FIG. 2A.

FIG. 3A and FIG. 3B are side views illustrating variations of the rotary device (in which the axis of a peripheral wall is inclined). FIG. 3A illustrates a mode in which one end wall of the airtight container is located higher than the other end wall. FIG. 3B illustrates a mode in which the one end wall of the airtight container is located lower than the other end wall.

FIG. 4 is a side view of a variation of the rotary device (in which the axis of the peripheral wall swings).

### DESCRIPTION OF THE EMBODIMENTS

### One Embodiment of Method for Producing Plastic Optical Fiber of the Present Invention

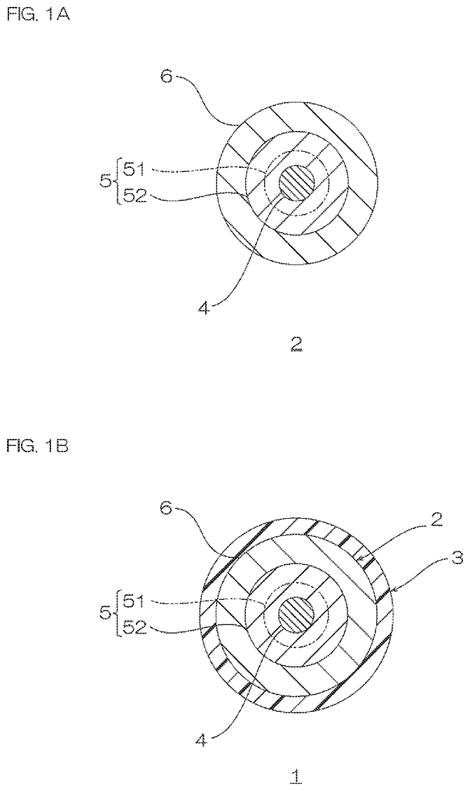

A plastic optical fiber produced by one embodiment of the method for producing a plastic optical fiber of the present invention is described with reference to FIG. 1B.

A plastic optical fiber 1 is a fiber extending in a longitudinal direction (corresponding to a direction in the depth of the paper sheet of the drawing of FIG. 1B). The plastic optical fiber 1 has an approximately circular shape in a cross section along a direction orthogonal to the longitudinal direction. The plastic optical fiber 1 includes a plastic optical fiber body 2 and a coloring member 3.

The plastic optical fiber body 2 is an optical transmission line that transmits light along the longitudinal direction. The plastic optical fiber body 2 has an approximately circular shape in a cross section orthogonal to an optical transmission direction in which light is transmitted.

The plastic optical fiber body 2 includes, for example, a core portion 4, a cladding portion 5, and an over-cladding portion 6 sequentially from the center toward the outside in the cross-sectional view.

The core portion 4 has an approximately circular shape in the cross-sectional view. The core portion 4 includes a center of the plastic optical fiber body 2 in the cross-sectional view.

The cladding portion 5 is disposed on an outer peripheral surface of the core portion 4. The cladding portion 5 is held between the core portion 4 and the over-cladding portion 6. The cladding portion 5 has an approximately ringed shape in the cross-sectional view. The cladding portion 5 has a refractive index lower than that of the core portion 4.

The over-cladding portion 6 is disposed on an outer peripheral surface of the cladding portion 5. The over-cladding portion 6 forms an outer peripheral surface of the plastic optical fiber body 2. The over-cladding portion 6 has an approximately ringed shape in the cross-sectional view.

The plastic optical fiber body 2 can have a double-cladding structure, depending on the use and purpose of the plastic optical fiber 1. In such a case, as the phantom lines of FIG. 1 show, the cladding portion 5 includes a first cladding portion 51 and a second cladding portion 52 disposed on an outer peripheral surface of the first cladding portion 51. In other words, the cladding portion 5 has a two-layered structure made from the first cladding portion 51 and the second cladding portion 52. The first cladding portion 51 has a refractive index lower than that of the core portion 4. The second cladding portion 52 has a refractive index lower than that of the first cladding portion 51. The over-cladding portion 6 has a refractive index lower than that of the second cladding portion 52.

The material making up the plastic optical fiber body 2 is plastic. The plastic is not especially limited, and examples thereof include thermoplastic resins, for example, acrylic resins (including fluorinated acrylic resin), poly carbonate resins (including modified polycarbonate resin such as polyester-modified polycarbonate resin), and olefin resins such as polyethylene resin, polypropylene resin, and cycloolefin resin. These can be used singly or in combination. The material of the plastic optical fiber body 2 is appropriately selected depending on the refractive indexes that the core portion 4, the cladding portion 5, and the over-cladding portion 6 require.

In particular, for the over-cladding portion 6, preferably, polycarbonate resin or olefin resin is used. Particularly preferably, modified polycarbonate resin or cycloolefin resin is used to achieve high reliability.

The plastic optical fiber body 2 is transparent. The plastic optical fiber body 2 has an entire light transmittance of, for example, 85% or more, preferably 90% or more, more preferably 90% or more, and, for example, 100% or less.

The plastic optical fiber body 2 has a diameter of, for example, 10 μm or more and 10 mm or less.

The coloring member 3 is disposed on the outer peripheral surface of the plastic optical fiber body 2. Specifically, the coloring member 3 is in contact with an outer peripheral surface of the over-cladding portion 6. The coloring member 3 forms an outer peripheral surface of the plastic optical fiber 1.

The coloring member 3 is colored. The coloring member 3 has an entire light transmittance of for example, less than 85%, preferably 80% or less, and, for example, 10% or more.

The coloring member 3 is made from a cured product of a curable composition containing an active-energy-ray-curable acrylate and a pigment. The curable composition is described below.

Without any particular limitation, the coloring member 3 has a thickness of, for example, 0.01 μm or more, preferably 0.1 μm or more, and, for example, 1000 μm or less, preferably 100 μm or less. A ratio of the thickness of the coloring member 3 to the diameter of the plastic optical fiber body 2 is, for example, 0.0001 or more, preferably 0.001 or more, and, for example, 1 or less, preferably 0.5 or less.

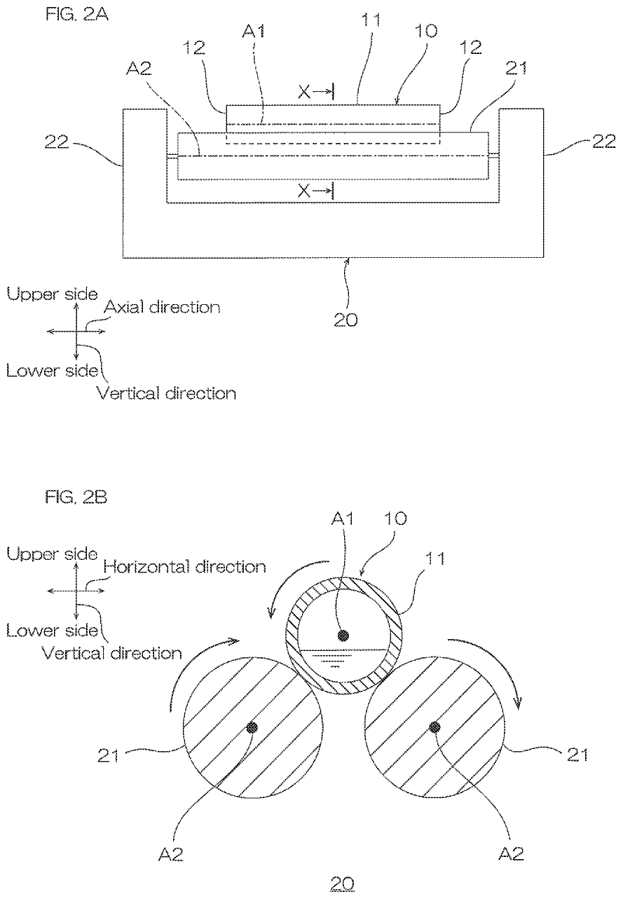

Next, a method for producing the plastic optical fiber 1 is described with reference to FIG. 1A and FIG. 2B.

As illustrated in FIG. 1A, the plastic optical fiber body 2 is prepared first in the method. The plastic optical fiber body 2 is produced by, for example, a melt extrusion process. In the melt extrusion process, the core portion 4, the cladding portion 5, and the over-cladding portion 6 are simultaneously formed.

Next, a curable composition is prepared. The curable composition contains an active-energy-ray-curable resin and a pigment.

Examples of the active-energy-ray-curable resin include active-energy-ray-curable multifunctional acrylate. The curable composition can contain an active-energy-ray-curable multifunctional acrylate and an active-energy-ray initiator.

Examples of the pigment are not especially limited and include white pigments, black pigments, yellow pigments, green pigments, red pigments, and blue pigments. The pigment has an average particle size of, for example, 1 nm or more and 100 μm or less.

The mixing ratio of each of the materials is set depending on the use and purpose of the plastic optical fiber 1. In the curable composition, a ratio of the active-energy-ray-curable resin is, for example, 50% by mass or more, preferably 75% by mass or more, and, for example, 99% by mass or less. Relative to 100 parts by mass of the active-energy-ray-curable resin, the pigment content is for example, 1 part by mass or more, and, for example, 25 parts by mass or less.

A commercially available product can be used as the curable composition. For example, the Optical Fiber Coloring Ink series (manufactured by PhiChem) is used.

The curable composition has a viscosity of 2,000 mPa or more and 3,000 mPa or less at 25° C. Preferably, the curable composition has a viscosity of 2,200 mPa or more and 2,800 mPa or less at 25° C.

When the curable composition has a viscosity of 2,000 mPa or more and 3,000 mPa or less at 25° C., the pigment can homogeneously be dispersed in the curable composition as described below.

The viscosity of the curable composition is obtained using a corn and plate viscometer in accordance with JIS K5600-2-3 (2014).

Next in the method, the pigment is dispersed in the curable composition.

For the dispersion of the pigment in the curable composition, as illustrated in FIG. 2A and FIG. 2B, for example, an airtight container 10 and a rotary device 20 are prepared.

The airtight container 10 has a circular tubular shape. The airtight container 10 has, for example, a peripheral wall 11 and two end walls 12. The peripheral wall 11 is a circular tube. The peripheral wall 11 has a hollow inside. An axis A1 passes through the hollow. The two end walls 12 are disposed on both ends of the peripheral wall 11 in an axial direction, sealing both ends of the hollow in the axial direction. Although not illustrated, the airtight container 10 may be composed of a body and a lid.

The rotary device 20 includes two rollers 21 and a bearing 22.

The two rollers 21 each have an axis A2 intersecting with a vertical line and specifically going along a horizontal direction. The axes A2 of the two rollers 21 are parallel to each other. The two rollers 21 face each other. Both axial-direction ends of each of the two rollers 21 are connected to the bearing 22. Surface layers of the rollers 21 are made of, for example, an elastic material such as rubber.

The bearing 22 rotatably supports the two rollers 21. The bearing 22 is connected to a motor capable of giving a driving force to one roller 21. Meanwhile, the other roller 21 is driven through the airtight container 10.

The curable composition is sealed in the airtight container 10. Subsequently, the airtight container 10 is set in the rotary device 20. Specifically, the curable composition is poured into the body and then the body is covered with the lid, thereby sealing the curable composition in the airtight container 10. Next, the peripheral wall 11 of the airtight container 10 is brought into contact with the peripheral surfaces of the two rollers 21. The airtight container 10 is disposed from above the two rollers 21. The peripheral wall 11 of the airtight container 10 is in point contact with each of the peripheral surfaces of the two rollers 21 in the cross-sectional view.

In this manner, the axis A1 of the peripheral wall 11 of the airtight container 10 intersects with the vertical line. Specifically, the axis A1 of the peripheral wall 11 of the airtight container 10 goes along the horizontal direction.

Subsequently, the motor of the rotary device 20 (not illustrated) is driven to rotate the one roller 21. Following the rotation, the airtight container 10 and the other roller 21 rotate.

The airtight container 10 rotates around the axis A1 of the peripheral wall 11.

The internal surface of the peripheral wall 11 rotates at a circumferential velocity CV of 0.02 m/sec or more and 0.2 m/sec or less, preferably 0.175 m/sec or less, more preferably 0.15 m/sec or less, even more preferably 0.1 m/sec or less, particularly preferably 0.12 m/sec or less, and further more preferably 0.1 m/sec or less, further more preferably 0.05 m/sec or less.

The circumferential velocity CV of the internal surface of the peripheral wall 11 is obtained from the external diameter and number of revolutions (rpm) of the roller 21, and the interior diameter and external diameter of the peripheral wall 11. Specifically, when the roller 21 has a diameter of 42 mm and the peripheral wall 11 has an interior diameter of 90 mm and an external diameter of 96 mm, the number of revolutions of the roller 21 is 10 rpm or more and 100 rpm or less, preferably 85 rpm or less, more preferably 70 rpm or less, even more preferably 60 rpm or less, particularly preferably 50 rpm or less, further more preferably 25 rpm or less, further more preferably 15 rpm or less.

When the circumferential velocity CV of the internal surface of the peripheral wall 11 exceeds 0.2 m/sec, air bubbles are mixed in the curable composition. When the circumferential velocity CV of the internal surface of the peripheral wall 11 is less than 0.02 m/sec, the pigment becomes inhomogeneous in the curable composition. The rotation of the airtight container 10 makes a region located near the internal surface of the peripheral wall 11 flow in a direction in which the peripheral wall 11 moves in the curable composition. In this manner, the pigment is moderately dispersed in the whole of the curable composition and the mixing of air bubbles is suppressed.

The time of the rotation of the airtight container 10, namely, the time of the dispersion of the pigment in the curable composition is not especially limited and, for example, 5 minutes or more, preferably 15 minutes or more, and, for example, 2 hours or less, preferably 1 hour or less.

A commercially available product can be used as the rotary device 20. For example, the Big Rotor series manufactured by AS ONE Corporation is used.

The curable composition contains the active-energy-ray-curable resin, which is a principal factor in the viscosity of the curable composition, in the above-described high content ratio (50% by mass or more) as a primary component. Thus, the viscosity of the curable composition does not change before and after the pigment is dispersed.

In this method, thereafter, the curable composition is applied on the outer peripheral surface of the plastic optical fiber body 2. Thereafter, the curable composition is irradiated with an active energy ray.

For the application of the curable composition, a known application device is used.

Examples of the active energy ray include ultraviolet rays (including UVA (long-wavelength ultraviolet rays) and UVB (short-wavelength ultraviolet rays)), α rays, β rays, γ rays, and X rays. Preferably, ultraviolet rays are used.

For the active energy ray irradiation, a light source and an irradiation chamber facing the light source are used.

In the method, the plastic optical fiber body 2 having the outer peripheral surface coated with the curable composition passes through the irradiation chamber of the irradiation device.

In this manner, the curable composition is cured, thereby producing a cured product of the curable composition. In this manner, the coloring member 3 made from the cured product is formed on the outer peripheral surface of the plastic optical fiber body 2.

### Operations and Effects of One Embodiment

In the method for producing the plastic optical fiber 1, the curable composition with a specific viscosity is charged into the airtight container 10, and the airtight container 10 is rotated around the axis AI so that the internal surface of the peripheral wall 11 rotates at a circumferential velocity of 0.02 m/sec or more, 0.2 m/sec or less, namely, a low speed. Thus, the mixing of air bubbles can be suppressed while the pigment homogeneously exists in the curable composition. As a result, the plastic optical fiber 1 is produced while the coloring member 3 has excellent distinguishability, and the defects of the coloring member 3 are suppressed.

### Variations

In each of the following variations, the same members and steps as in the above-described embodiment will be given the same numerical references and the detailed description will be omitted. Further, the variations can have the same operations and effects as those of the embodiment unless especially described otherwise. Furthermore, the embodiment and the variations can appropriately be combined.

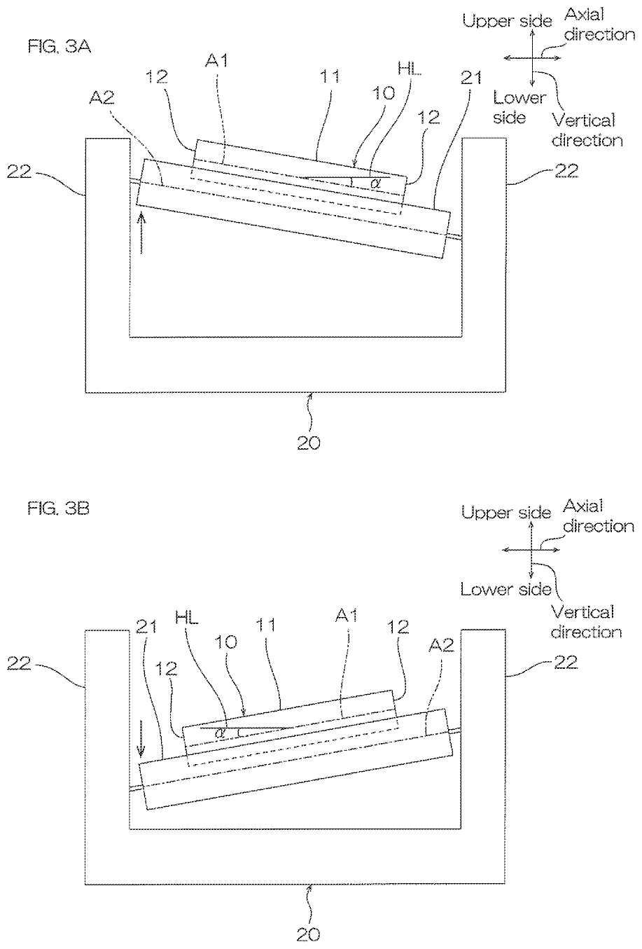

In the above-described method of dispersing the pigment, the axis A1 of the peripheral wall 11 of the airtight container 10 goes along the horizontal direction. However, the axis A1 is only required to intersect with the vertical line. For example, as illustrated in FIG. 3A, the axis A1 can be inclined from a horizontal line HL. The variation demonstrates a roller 21 having an axis A2 inclined from the vertical line and the horizontal line HL. An inclination angle α formed by the axis A1 of the peripheral wall 11 and the horizontal line HL is, for example, 5 degrees or less, preferably, 3 degrees or less.

As illustrated in FIG. 3A and FIG. 3B, the one end wall 12 can repeatedly be moved up and down so that the axis A1 of the peripheral wall 11 of the airtight container 10 swings while the airtight container 10 rotates. The speed at which the one end wall 12 moves is set to a value at which air bubbles are not mixed in the curable composition (a very low speed). For example, the one end wall 12 moves up and down at a speed of, for example, 0.01 m/sec or less, preferably 0.001 m/sec or less.

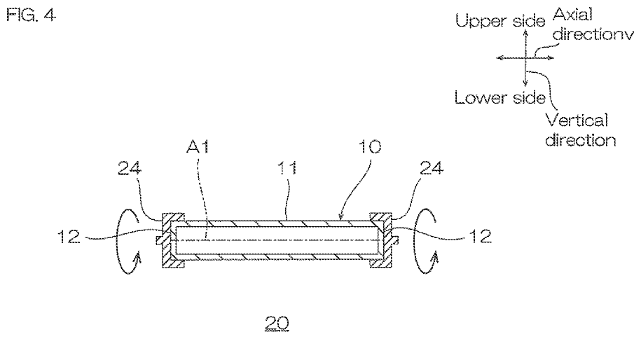

The rotary device 20 includes the rollers 21. As illustrated in FIG. 4, the rotary device 20 can include, for example, two holder portions 24 that rotatably hold both the axial-direction ends of the peripheral wall 11.

The peripheral wall 11 is only required to have a circular tubular shape. Although not illustrated, however, the peripheral wall 11 may have a circular tubular portion and a tapered portion continuing to an end of the circular tubular portion. The tapered portion has a shape with an opening of which cross-sectional area gradually decreases toward an end of the tapered portion (one side in the axial direction).

The plastic optical fiber 1 has an approximately circular shape in the cross-sectional view. The shape, however, is not especially limited. Although not illustrated, the shape may be, for example, an approximately rectangular shape in the cross-sectional view.

FIG. 1 shows that the plastic optical fiber body 2 includes the core portion 4, the cladding portion 5, and the over-cladding portion 6. Although not illustrated, for example, the plastic optical fiber body 2 does not include an over-cladding portion 6, and may include only a core portion 4 and a cladding portion 5.

In the production method, the pigment is dispersed in the curable composition before the application by a method that suppresses the mixing of air bubbles, for example, by using the above-described rotary device 20. For example, the above-described curable composition can be shear mixed by a stirring blade of a disperser, and then left to stand for, for example, 1 hour or more, preferably 24 hours or more to remove the air bubbles. Thereafter, the pigment of the curable composition is dispersed again with the rotary device 20.

### Example

The present invention is described in more detail below with reference to Examples and Comparative Examples. The present invention is not limited to Examples and Comparative Examples in any way. The specific numeral values used in the description below, such as mixing ratios (contents), physical property values, and parameters can be replaced with the corresponding mixing ratios (contents), physical property values, and parameters in the above-described “DESCRIPTION OF THE EMBODIMENTS”, including the upper limit values (numeral values defined with “or less”, and “less than”) or the lower limit values (numeral values defined with “or more”, and “more than”).

### Example 1

A plastic optical fiber body 2 with an external diameter of 470 μm, which includes a core portion 4 made of polymethylmethacrylate (PMMA) (manufactured by Mitsubishi Chemical Corporation), a cladding portion 5 made of fluorinated PMMA (manufactured by Daikin Industries, Ltd. FM450), and an over-cladding portion 6 made of XYLEX X7300CL (trade name, manufactured by SABIC Innovative Plastic, polyester-modified polycarbonate resin), was produced by a melt extrusion process.

Optical Fiber Coloring Ink aqua (containing an active-energy-ray-curable multifunctional acrylate and a blue pigment, and manufactured by PhiChem) was prepared as a curable composition.

Subsequently, 500 mL of the prepared curable composition was charged into a 1000 mL airtight container 10 (with an interior diameter of 90 mm and an external diameter of 96 mm). Subsequently, the airtight container 10 was set in a rotary device 20. The rotary device 20 was Big Rotor (model number BR-2, manufactured by AS ONE Corporation.). Both of an axis A1 of the peripheral wall 11 of the airtight container 10 and axes A2 of rollers 21 went along a horizontal direction.

Subsequently, one roller 21 was rotated so that an internal peripheral surface of the peripheral wall 11 of the airtight container 10 rotates at a circumferential velocity of 0.055 m/sec (the number of revolutions of the rollers 21 was 27 rpm). In this manner, the pigment was dispersed in the curable composition for 30 minutes.

Thereafter, the curable composition was taken out of the airtight container 10. Immediately afterward, the curable composition was applied on the outer peripheral surface of the plastic optical fiber body. Subsequently, the curable composition was irradiated with ultraviolet rays to cure the curable composition, thereby forming a coloring member with a thickness of 20 μm.

### Examples 2 to 10 and Comparative Example 1

Plastic optical fibers 1 were produced in the same manner as Example 1 except that the type of the curable composition and the circumferential velocity CV of the internal surface of the peripheral wall 11 were changed in accordance with Table 1.

### Comparative Example 2

A plastic optical fiber 1 was produced in the same manner as Example 2 except that a disperser (model number BL300, manufactured by Shinto Scientific Co., Ltd.) including a stirring blade with a diameter of 0.07 m was used in place of the rotary device 20 to stir the curable composition. The number of revolutions of the stirring blade was 15 rpm and the edge circumferential velocity of the stirring blade was 0.055 m/sec.

### Example 11

A curable composition was stirred with the disperser of Comparative Example 2, and then left to stand for 24 hours to remove the air bubbles. The pigment was dispersed again in the curable composition in the same method as Example 1. Subsequently, the same process as Example 1 was carried out, thereby produce a plastic optical fiber 1.

### Comparative Example 3

The same process as Example 1 was carried out, thereby produce a plastic optical fiber 1 except that the curable composition, which had not been stirred and thus was in an inhomogeneous state, was applied on the outer peripheral surface of the plastic optical fiber body.

### Evaluation

The following items of each of Examples and Comparative Examples were evaluated.

### Viscosity of Curable Composition

The viscosity of the curable composition at 25° C. was obtained after the dispersion and before the application in conformity with JIS K5600-2-3 (2014) using a corn and plate viscometer. Model “RE80” manufactured by TOKI SANGYO CO., LTD was used as the corn and plate viscometer (E type viscometer).

### Presence or Absence of Defect of Coloring Member

The coloring member 3 of a 50 m plastic optical fiber 1 was visually checked. The defect of the coloring member 3 was evaluated based on the following criteria.

Bad: A defect due to an air bubble was confirmed in the coloring member 3
Good: No defect due to an air bubble was confirmed in the coloring member 3

### Distinguishability of Coloring Member

By visually checking the coloring member 3, the distinguishability was evaluated based on the following criteria.

Bad: A hole due to the inhomogeneity of the pigment was confirmed.
Good: The above-described hole was not confirmed.

TABLE 1

| | | | Stirring conditions | | | | Evaluation | |
|---|---|---|---|---|---|---|---|---|
| Example• | Curable composition | | | | Circumferential velocity | Number of | Defect of | |
| Comparative | | Viscosity | Stirring | Stirring | CV (m/sec) of internal surface | revolutions | coloring | |
| Example | Type | (mPa) | method | blade | of peripheral wall | (rpm) | member | Distinguishability |
| Example 1 | Aqua*² | 2550 | Big rotor | Absence | 0.055 | 27 | Good | Good |
| Example 2 | Blue*³ | 2600 | Big rotor | Absence | 0.055 | 27 | Good | Good |
| Example 3 | Orange*⁴ | 2800 | Big rotor | Absence | 0.055 | 27 | Good | Good |
| Example 4 | Pink*⁵ | 3000 | Big rotor | Absence | 0.055 | 27 | Good | Good |
| Example 5 | Blue*³ | 2600 | Big rotor | Absence | 0.025 | 12 | Good | Good |
| Example 6 | Blue*³ | 2600 | Big rotor | Absence | 0.080 | 40 | Good | Good |
| Example 7 | Blue*³ | 2600 | Big rotor | Absence | 0.110 | 53 | Good | Good |
| Example 8 | Blue*³ | 2600 | Big rotor | Absence | 0.135 | 65 | Good | Good |
| Example 9 | Blue*³ | 2600 | Big rotor | Absence | 0.160 | 80 | Good | Good |
| Example 10 | Blue*³ | 2600 | Big rotor | Absence | 0.190 | 93 | Good | Good |
| Example 11 | Blue*³ | 2600 | Disperser → | Presence | (0.055) | (15) | Good | Good |
| | | | Big rotor*¹ | →Absence | →0.055 | →27 | | |
| Comparative | Blue*³ | 2600 | Big rotor | Absence | 0.210 | 107 | Bad | Good |
| Example 1 | | | | | | | | |
| Comparative | Blue*³ | 2600 | Disperser | Presence | (0.055) | (15) | Bad | Good |
| Example 2 | | | | | | | | |

| | | | | | |
|---|---|---|---|---|---|
| Comparative | Blue*³ | 2600 | — | Good | Bad |
| Example 3 | | | | | |

*¹The pigment was dispersed with a disperser, left to stand for 24 hours, and then dispersed with a big rotor.
*²Aqua: Optical Fiber Coloring Ink aqua (manufactured by PhiChem)
*³Blue: Optical Fiber Coloring Ink blue (manufactured by PhiChem)
*⁴Orange: Optical Fiber Coloring Ink orange (manufactured by PhiChem)
*⁵Pink: Optical Fiber Coloring Ink pink (manufactured by PhiChem)

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The plastic optical fiber is used for various types of optical transmission.

Description of Reference Numerals

| | |
|---|---|
| 1 | plastic optical fiber |
| 2 | plastic optical fiber body |
| 3 | coloring member |

1. A method for producing a plastic optical fiber, the method comprising:
a step of dispersing a pigment in a curable composition containing an active-energy-ray curable resin and the pigment; and
a step of forming a coloring member made from a cured product of the curable composition by applying the curable composition on a peripheral surface of a plastic optical fiber body, wherein
the curable composition has a viscosity of 2,000 mPa or more and 3,000 mPa or less at 25° C., and
in the step of dispersing the pigment, the curable composition is charged into an airtight container having a circular tubular shape with an axis and the airtight container is rotated around the axis intersecting with a vertical line so that an internal surface of the circular tube rotates at a circumferential velocity of 0.02 m/sec or more and 0.2 m/sec or less.
